(19) United States
(12) Patent Application Publication
(10) Pub. No.: US 2020/0108494 A1
(43) Pub. Date: Apr. 9, 2020

(54) POWER MECHANISM AND HANDHELD TOOL USING THE SAME

(71) Applicant: Fairway Electronic Co., Ltd., New Taipei City (TW)

(72) Inventors: Lin-Han YEN, New Taipei City (TW); Chien-Hsiung HSIEH, New Taipei City (TW); Yu-Jen FANG, New Taipei City (TW)

(21) Appl. No.: 16/299,755

(22) Filed: Mar. 12, 2019

(30) Foreign Application Priority Data
Oct. 8, 2018 (TW) 107135465

(51) Int. Cl. B25F 5/00; H02K 7/14; H02K 7/116; H02K 11/21; H02K 11/25; F16H 37/04; F16H 1/28; F16H 1/16; A46B 13/00; A46B 13/02

(52) U.S. Cl. CPC B25F 5/001; H02K 7/145; H02K 7/1166; H02K 11/21; H02K 11/25; B24B 47/12; F16H 1/28; F16H 1/16; A46B 13/008; A46B 13/02; F16H 37/041

(57) ABSTRACT

A power mechanism and a handheld tool using the same are provided. The power mechanism comprises a motor, a worm, an epicyclic gearing set and a controlling board. The worm is driven by the motor. The epicyclic gearing set is engaged with the worm. The controlling board is used to control the on/off or operating state of the motor.

### RELATED APPLICATIONS

The present application claims the priority of Taiwan Application No. 107135465, filed Oct. 8, 2018, the disclosure of which is hereby incorporated by reference herein in its entirety.

### BACKGROUND OF THE INVENTION

### 1. Field of the Invention

The present disclosure generally relates to a power mechanism and a handheld tool using the same, and, more particularly, to a power mechanism using a motor as the main mechanical power (kinetic energy) source and a handheld tool using the same.

### 2. Description of the Related Art

In general, most of the handheld tools on the current market use the brush motor to directly drive the transmission shaft and the tool part (such as a grinding disc, a drill bit, etc.). However, such a configuration has a very poor power conversion efficiency. For example, the power conversion efficiency of the brush motor direct drive is only about 40%. In addition, the handheld tools of the prior art are not stable in the rotating speed control and only able to provide very low torque.

Therefore, how to provide a power mechanism with high power conversion efficiency, stable rotating speed and high torque, and a hand tool using the power mechanism, which has become an urgent problem to be solved in the industry.

### SUMMARY OF THE INVENTION

In light of solving the foregoing problems of the prior art, one purpose of the present invention is to provide a power mechanism with high power conversion efficiency, stable rotating speed and high torque, and a hand tool using the power mechanism.

In order to achieve the above purposes, the power mechanism according to the present invention applied to a handheld tool comprises a motor, a worm, an epicyclic gearing set and a controlling board. The worm is driven by the motor. The epicyclic gearing set is engaged with the worm. The controlling board is used to control the on/off or operating state of the motor.

In an embodiment, the motor is a brushless DC motor.

In an embodiment, the controlling board has the function of field-oriented control (FOC).

In an embodiment, the epicyclic gearing set comprises a worm gear, a sun gear, a plurality of outer gears, an outer ring gear and a carrier, wherein the sun gear is coaxial with the worm gear, the worm gear is engaged with the worm, the sun gear is engaged with the plurality of outer gears by being assembled on the carrier, the outer ring gear is engaged with the plurality of outer gears, and the carrier is configured to connect an external transmission shaft.

In an embodiment, the controlling board further comprises a temperature sensing module which is used to sense the temperature inside the handheld tool.

In an embodiment, when the temperature sensed by the temperature sensing module is greater than a temperature default value, the temperature sensing module sends a first signal to slow down or stop the motor.

In an embodiment, the controlling board further comprises a pressure sensing module which is used to sense the pressure applied on the handheld tool.

In an embodiment, when the pressure sensed by the pressure sensing module is greater than a first pressure default value, the pressure sensing module sends a second signal to slow down or stop the motor.

In an embodiment, when the pressure sensed by the pressure sensing module is greater than a second pressure default value, the pressure sensing module sends a third signal to cause the motor to repeatedly stop and start.

In an embodiment, the controlling board further comprises a rotating speed detection module which is used to feedback control the motor to reach a default rotating speed and determine the operating state of the motor.

In an embodiment, the power mechanism further comprises a inner casing, and the worm and the epicyclic gearing set are disposed inside the inner casing.

The present invention also provides a handheld tool comprising a outer casing, a power mechanism according to one of the above embodiments, a controlling interface, a transmission shaft, a tool part and a power module. The power mechanism is disposed inside the outer casing. The controlling interface is electrically connected to the controlling board of the power mechanism for inputting the control signal. The transmission shaft is coupled with the power mechanism. The tool part is coupled with the transmission shaft. The power module is used for supplying power required for operation of the power mechanism.

Compared to the prior art, the power mechanism according to the present invention applied to a handheld tool comprises a motor, a worm, an epicyclic gearing set and a controlling board. The mechanical power (kinetic energy) is supplied by the motor. The worm has the function of changing power direction, deceleration, etc. The epicyclic gearing set also has the function of deceleration and excellent transmission efficiency. Due to the characteristics of the worm and the epicyclic gear set, the power mechanism according to the present invention has high power conversion efficiency and high torque at low speed output. It can also provide rotating speeds to adapt to various states due to controlling the operating state of the motor by the controlling board. Further, it can increase torque, power conversion efficiency and more stable rotating speed by applying a brushless DC motor and a controlling board with the function of field-oriented control. In addition, the controlling board of the power mechanism according to the present invention may further comprise a temperature sensing module or a pressure sensing module to reduce the risk of abnormal conditions. The handheld tool using the power mechanism according to the present invention also has the above advantages. The disadvantages of the prior art are fully solved.

### BRIEF DESCRIPTION OF THE DRAFLAPS

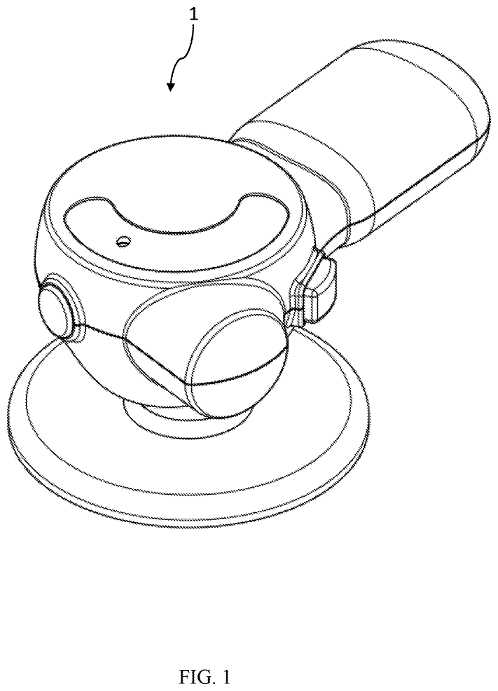

FIG. 1 illustrates a schematic appearance of a handheld tool according to a first embodiment of the present invention;

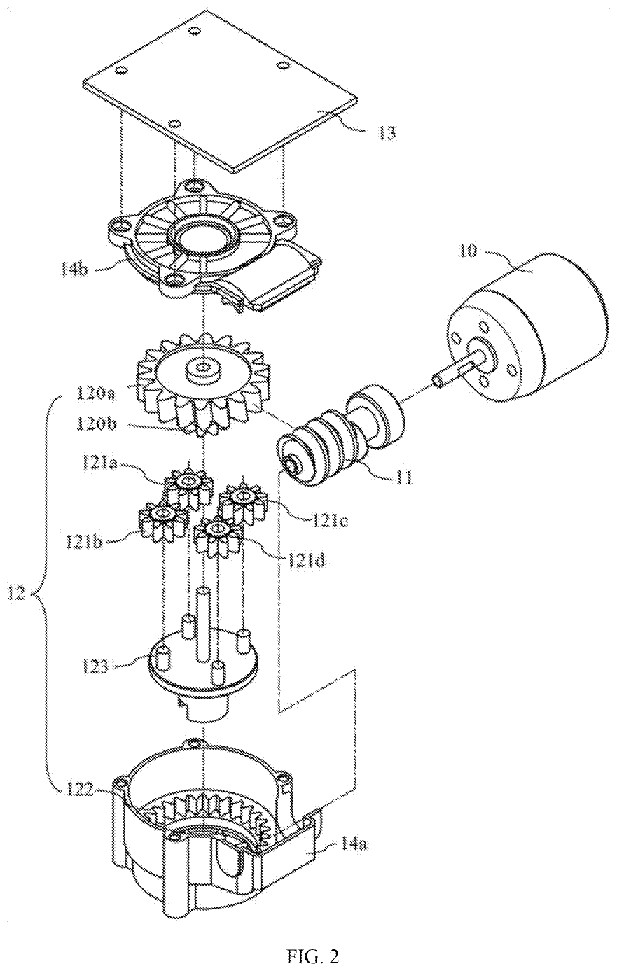

FIG. 2 illustrates a schematic exploded view of a power mechanism according to a second embodiment of the present invention;

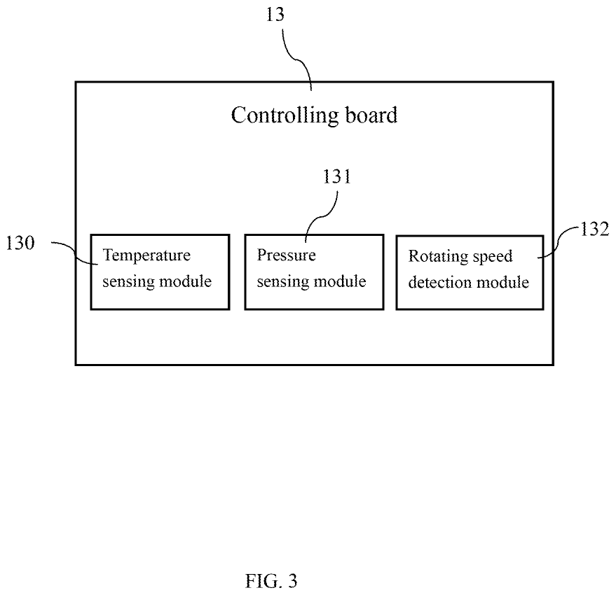

FIG. 3 illustrates a functional block diagram of a controlling board according to a third embodiment of the present invention; and

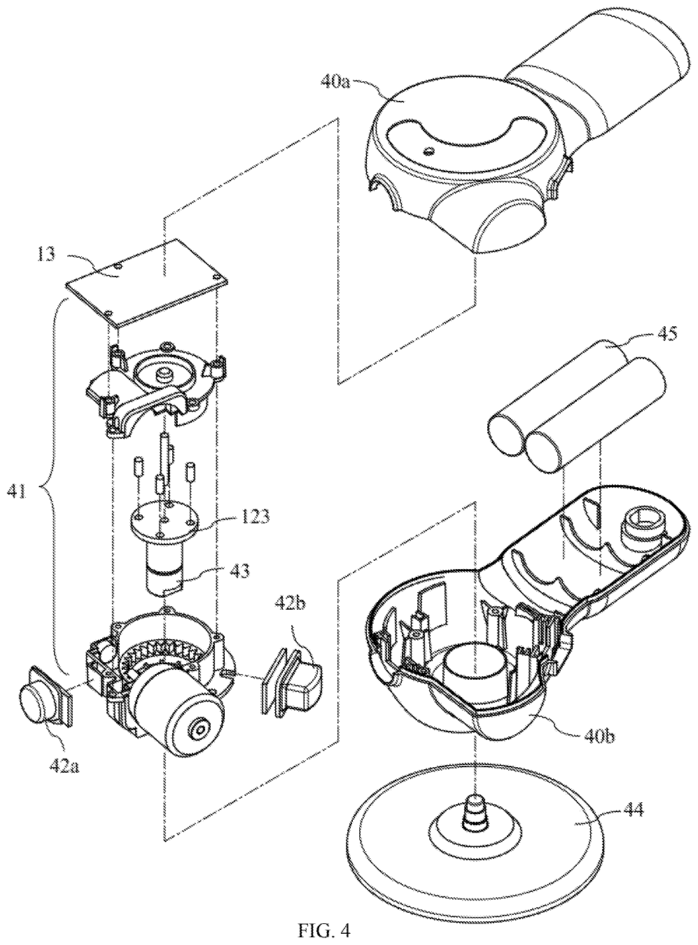

FIG. 4 illustrates a schematic exploded view of a power mechanism according to a fourth embodiment of the present invention.

### DETAILED DESCRIPTION

The present invention is described by the following specific embodiments. Those with ordinary skills in the arts can readily understand other advantages and functions of the present invention after reading the disclosure of this specification. Any changes or adjustments made to their relative relationships, without modifying the substantial technical contents, are also to be construed as within the range implementable by the present invention.

Please refer to FIG. 1. FIG. 1 illustrates a schematic appearance of a handheld tool according to a first embodiment of the present invention. The power mechanism according to the present invention is applied to a handheld tool 1 as shown in FIG. 1. Further, the handheld tool 1 uses a motor as main mechanical power (kinetic energy) source and is easy to handheld use.

In general, handheld tools are often used for cleaning, grinding, waxing, etc. In the case of cleaning, the tool part (such as a brush) of a handheld tool will touch the object and cause friction. Therefore, the power mechanism of the handheld tool must provide sufficient torque to have a cleaning effect, which is the same for handheld tools used in other applications.

Please refer to FIG. 2. FIG. 2 illustrates a schematic exploded view of a power mechanism according to a second embodiment of the present invention. As shown, the power mechanism according to the present invention comprises a motor 10, a worm 11, an epicyclic gearing set 12 and a controlling board 13. The mechanical power (kinetic energy) is supplied by the motor 10. The worm 11 is driven by the motor 10 to rotate. The epicyclic gearing set 12 is engaged with the worm 11. The controlling board 13 is used to control the on/off or operating state of the motor 10.

The worm 11 can change the power direction. Compared with the handheld tool in the prior art, the handheld tool according to the present invention can install the motor 10 in different directions and adjust the overall center of gravity to be more suitable for handheld use. In addition, decelerating by using the worm 11 to fit gears can save more volume as compared with decelerating by using gears to fit gears.

The epicyclic gearing set 12 also has the function of deceleration to further reduce the output rotating speed. Further, the epicyclic gearing set 12 has excellent transmission efficiency. Due to the characteristics of the worm 11 and the epicyclic gear set 12, the power mechanism according to the present invention has high power conversion efficiency and high torque at low speed output.

The controlling board 13 is a circuit board having the control function. The controlling board 13 can be used to control the on/off or operating state of the motor 10, including controlling the rotating speed of the motor 10. In the prior art, the design without the controlling board only allows the motor to operate at a default rotating speed. However, the power mechanism according to the present invention can control the operating state of the motor 10 by the controlling board 13 to adjust rotating speed for various states. For example, it can have a soft start design that gradually increases the rotating speed instead of violently accelerating when the motor 10 is turned on. It also can set a plurality sets of default rotating speed.

In a further example, the controlling board 13 can also slow down or stop the motor 10 to give the tool part a greater friction. When a handheld tool is used for cleaning or grinding, sometimes more friction is needed to handle special conditions. Further, when the tool part is started from low speed or stopping state, it can get more friction than continuous high speed operation. Therefore, controlling the motor 10 to repeatedly slow down, stop, and start by the controlling board 13 allows the handheld tool to achieve better cleaning or grinding capabilities.

In an embodiment, the motor 10 could be a brushless DC (BLDC) motor. The brushless DC motor has a higher torque at the same volume than the brush motor used in the prior art. The brushless DC motor uses the trapezoidal shape of the counter-electromotive force (the voltage is applied into the stator winding due to rotor motion) to detect displacement on the rotor. It is used to create a rotating magnetic field with low torque fluctuations.

In an embodiment, the controlling board 13 has the function of field-oriented control (FOC). FOC function can accurately control the intensity and direction of the magnetic field. It allows the motor 10 has a stable torque, low noise and high efficiency, and fast dynamic response.

In an embodiment, the epicyclic gearing set 12 comprises a worm gear 120a, a sun gear 120b, a plurality of outer gears 121a, 121b, 121c, 121d, an outer ring gear 122 and a carrier 123. The sun gear 120b is coaxial with the worm gear 120a. The worm gear 120a is engaged with the worm 11. The sun gear 120b is engaged with the plurality of outer gears 121a, 121b, 121c, 121d by being assembled on the carrier 123. The outer ring gear 122 is engaged with the plurality of outer gears 121a, 121b, 121c, 121d. The carrier 123 is configured to connect an external transmission shaft (as described later). During operation, the worm gear 120a and the sun gear 120b serve as a power input port, the outer ring gear 122 is fixed, and the carrier 123 serves as a power output port. This configuration has the effect of reducing the rotating speed. It should be noted that, the number of the outer gears 121a, 121b, 121c, and 121d is four in this embodiment, but not limited thereto. There could be a different number of outer gears in other embodiments.

Please refer to FIG. 3. FIG. 3 illustrates a functional block diagram of a controlling board according to a third embodiment of the present invention. In an embodiment, the controlling board 13 further comprises a temperature sensing module 130 which is used to sense the temperature inside the handheld tool.

In an embodiment, when the temperature sensed by the temperature sensing module 130 is greater than a temperature default value, the temperature sensing module 130 sends a first signal to slow down or stop the motor 10. When the handheld tool is not operating in a proper way, the internal temperature of the handheld tool will rise. The temperature can be sensed by the temperature sensing module 130, thereby to let the motor 10 slow down or stop before the component is damaged.

In an embodiment, the controlling board 13 further comprises a pressure sensing module 131 which is used to sense the pressure applied on the handheld tool. In detail, the user will press the tool part on other objects when using the handheld tool. The user will also exert a certain pressure in order to achieve good cleaning, grinding and other effects. However, the components of the handheld tool could be damaged if the pressure applied on the handheld tool is too high.

In an embodiment, the pressure sensed by the pressure sensing module 131 is greater than a first pressure default value, the pressure sensing module 131 sends a second signal to slow down or stop the motor 10. In order to avoid excessive pressure applied on the handheld tool, the pressure sensing module 131 senses the pressure and causes the motor 10 to reduce the speed or stop the operation before the components are damaged.

In an embodiment, the pressure sensed by the pressure sensing module 131 is greater than a second pressure default value, the pressure sensing module 131 sends a third signal to cause the motor 10 to repeatedly stop and start. As mentioned, when the tool part is started from low speed or stopping state, it can get more friction than continuous high speed operation. Therefore, controlling the motor 10 to repeatedly slow down, stop, and start by the controlling board 13 allows the handheld tool to achieve better cleaning or grinding capabilities. By setting the second pressure default value, the user can trigger the function by applying pressure to the handheld tool.

In another embodiment, the controlling board 13 also has a rotating speed compensation function to measure the rotating speed of the handheld tool at any time and compensate. In the other word, when the pressure is less than the aforementioned first pressure or the second pressure default value, or even when the handheld tool is in the idling state, the controlling board 13 will continue to measure and compensate the rotating speed.

In an embodiment, the controlling board 13 further comprises a rotating speed detection module 132 which is used to feedback control the motor 10 to reach a default rotating speed and determine the operating state of the motor 10. When the user activates the handheld tool with the power mechanism, the rotating speed detection module 132 outputs a rotating speed setting signal according to the setting to detect rotating speed of the motor 10, and obtains a feedback signal. When the feedback signal is not the feedback signal preset by the rotation speed detection module 132, it is determined that the current rotating speed is slow. At this time, the controlling board 13 controls the motor 10 to accelerate and the rotating speed detection module 132 continuously captures the instant feedback signal. It will continue to accelerate until the preset feedback signal is successfully captured. When the preset feedback signal is captured, the rotating speed detection module 132 determines that the motor 10 has reached the preset rotation speed. In addition, when the rotating speed setting signal outputted by the rotating speed detection module 132 is too different from the captured feedback signal, it is determined that the motor 10 is locked.

Please refer to FIG. 2. In an embodiment, the power mechanism further comprises inner casings 14a, 14b, and the worm 11 and the epicyclic gearing set 12 are disposed inside the inner casings 14a, 14b. The inner casings 14a, 14b can protect, isolate or assist to fix the worm 11 and the epicyclic gearing set 12 and the like. In this embodiment, the inner casings 14a, 14b are formed by a combination of two components, and the inner casing 14a is also combined with the outer ring gear 122, but not limited thereto. In other embodiments, the inner casing may also be otherwise formed or combined with other components.

Please refer to FIG. 4. FIG. 4 illustrates a schematic exploded view of a power mechanism according to a fourth embodiment of the present invention. The present invention also provides a handheld tool comprising outer casings 40a, 40b, a power mechanism 41 according to one of the above embodiments, controlling interfaces 42a, 42b, a transmission shaft 43, a tool part 44 and a power module 45.

In an embodiment, the power mechanism 41 is disposed inside the outer casings 40a, 40b. In this embodiment, the outer casings 40a, 40b are formed by a combination of two components, but not limited thereto. The power mechanism 41 is disposed in an accommodation space formed by the combination of the outer casings 40a and 40b, and the power mechanism 41 and the outer casings 40a, 40b can be coupled by other fixing components.

In an embodiment, the controlling interfaces 42a, 42b are electrically connected to the controlling board 13 of the power mechanism 41 for inputting the control signal. For example, the controlling interface 42a can be a turntable for inputting the control signal of the rotating speed, and controlling interface 42b can be a button for inputting the control signal of the switch, but not limited thereto. The controlling interfaces 42a, 42b can be electrically connected to the controlling board 13 by wires.

In an embodiment, the transmission shaft 43 is coupled with the power mechanism 41. The tool part 44 is coupled with the transmission shaft 43. The transmission shaft 43 is used to transmit the power provided by the power mechanism 41 to the tool part 44 to rotate the tool part 44. In this embodiment, the transmission shaft 43 is directly connected to the carrier 123 of the power mechanism 41, but not limited thereto. In other embodiments, the transmission shaft 43 can be indirectly coupled to the carrier 123 or otherwise coupled to the power mechanism 41.

In an embodiment, the tool part 44 can be a brush or a grinding disc, but not limited thereto. It can be replaced according to the purpose.

In an embodiment, the power module 45 is used for supplying power required for operation of the power mechanism 41. For example, the power module 45 can be a rechargeable battery or a power cable for connecting to an external power source, but not limited thereto.

In summary, the power mechanism according to the present invention applied to a handheld tool comprises a motor, a worm, an epicyclic gearing set and a controlling board. The mechanical power (kinetic energy) is supplied by the motor. The worm has the function of changing power direction, deceleration, etc. The epicyclic gearing set also has the function of deceleration and excellent transmission efficiency. Due to the characteristics of the worm and the epicyclic gear set, the power mechanism according to the present invention has high power conversion efficiency and high torque at low speed output. It can also provide rotating speeds adapt to various states due to controlling the operating state of the motor by the controlling board. Further, it can increase torque, power conversion efficiency and more stable rotating speed by applying a brushless DC motor and a controlling board with the function of field-oriented control. In addition, the controlling board of the power mechanism according to the present invention may further comprise a temperature sensing module or a pressure sensing module to reduce the risk of abnormal conditions. The handheld tool using the power mechanism according to the present invention also has the above advantages. The disadvantages of the prior art are fully solved.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

1. A power mechanism applied to a handheld tool, the power mechanism comprising:
a motor;
a worm driven by the motor;
an epicyclic gearing set engaged with the worm; and
a controlling board used to control the on/off or operating state of the motor.

2. The power mechanism of claim 1, wherein the motor is a brushless DC motor.

3. The power mechanism of claim 2, wherein the controlling board has the function of field-oriented control.

4. The power mechanism of claim 1, wherein the epicyclic gearing set comprises a worm gear, a sun gear, a plurality of outer gears, an outer ring gear and a carrier, wherein the sun gear is coaxial with the worm gear, the worm gear is engaged with the worm, the sun gear is engaged with the plurality of outer gears by being assembled on the carrier, the outer ring gear is engaged with the plurality of outer gears, and the carrier is configured to connect an external transmission shaft.

5. The power mechanism of claim 1, wherein the controlling board further comprises a temperature sensing module which is used to sense the temperature inside the handheld tool.

6. The power mechanism of claim 5, wherein when the temperature sensed by the temperature sensing module is greater than a temperature default value, the temperature sensing module sends a first signal to slow down or stop the motor.

7. The power mechanism of claim 1, wherein the controlling board further comprises a pressure sensing module which is used to sense the pressure applied on the handheld tool.

8. The power mechanism of claim 7, wherein when the pressure sensed by the pressure sensing module is greater than a first pressure default value, the pressure sensing module sends a second signal to slow down or stop the motor.

9. The power mechanism of claim 7, wherein the pressure sensed by the pressure sensing module is greater than a second pressure default value, the pressure sensing module sends a third signal to cause the motor to repeatedly stop and start.

10. The power mechanism of claim 1, wherein the controlling board further comprises a rotating speed detection module which is used to feedback control the motor to reach a default rotating speed and determine the operating state of the motor.

11. The power mechanism of claim 1, further comprising a inner casing, and the worm and the epicyclic gearing set are disposed inside the inner casing.

12. A handheld tool, comprising:
a outer casing;
a power mechanism according to claim 1, wherein the power mechanism is disposed inside the outer casing;
a controlling interface electrically connected to the controlling board of the power mechanism for inputting the control signal;
a transmission shaft being coupled with the power mechanism;
a tool part being coupled with the transmission shaft; and
a power module used for supplying power required for operation of the power mechanism.
